(19) United States
(12) Patent Application Publication
(10) Pub. No.: US 2025/0278181 A1
(43) Pub. Date: Sep. 4, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, TOKYO (JP)

(72) Inventor: YOSHINORI HASHIMOTO, TOKYO (JP)

(21) Appl. No.: 19/062,473

(22) Filed: Feb. 25, 2025

(30) Foreign Application Priority Data
Mar. 4, 2024 (JP) 2024-031958

(51) Int. Cl. G06F 3/04845; G06F 3/0482; G06F 3/0483; G06T 11/60

(52) U.S. Cl. CPC G06F 3/04845; G06F 3/0482; G06F 3/0483; G06T 11/60; G06T 2200/24

(57) ABSTRACT

A control method of an information processing apparatus includes: performing control to maintain a state in which second content data is included in a second list indicated by a second region displayed after a second editing screen is displayed even in a case where the second content data is selected from the second list; and performing control to newly add third content data to a first list displayed after an operation to save the third content data without outputting is performed on the second editing screen.

### BACKGROUND OF THE INVENTION

### Field of the Invention

The present disclosure relates to an information processing apparatus, a control method of the information processing apparatus, and a storage medium.

### Description of the Related Art

There is a content creation application that designs a poster, a photo album, a photograph layout, or the like by arranging an object such as an image or a text in an editing region on a screen. In the above-mentioned application, content data that is “under editing” or “outputted” is saved in the application.

In the above-mentioned application, there is a technique called “preflight check” for previous analysis of the content data before being outputted to check whether the object is arranged properly. Japanese Patent Laid-Open No. 2009-9230 describes a technique in which, in a case of executing the preflight check to prompt a revision from a user, editing of only a portion that needs the revision is allowed while editing of a portion that does not need the revision is not allowed.

There has been demanded a technique of suppressing inadvertent editing of an outputted content.

### SUMMARY OF THE INVENTION

A control method of an information processing apparatus according to an aspect of the present disclosure includes: generating content data; editing the content data based on a user operation; outputting the content data on which the editing is performed; displaying a first region indicating a first list, which is a list of the content data that is not outputted yet; displaying a second region indicating a second list, which is a list of the content data that is outputted already; displaying a first editing screen to edit first content data in a case where the first content data is selected from the first list; displaying a second editing screen to edit third content data obtained by duplicating second content data in a case where the second content data is selected from the second list; performing control to maintain a state in which the second content data is included in the second list indicated by the second region displayed after the second editing screen is displayed even in a case where the second content data is selected from the second list; and performing control to newly add the third content data to the first list displayed after an operation to save the third content data without outputting is performed on the second editing screen.

Further features of the present invention will become apparent from the following description of exemplary embodiments with reference to the attached drawings.

### BRIEF DESCRIPTION OF THE DRAWINGS

FIG. 1 is a diagram illustrating a configuration of an information processing system;

FIG. 2 is a flowchart illustrating an example of processing of a Web application;

FIG. 3 is a diagram illustrating an example of a screen in the Web application;

FIG. 4 is a diagram illustrating an example of a preflight check screen;

FIGS. 5A and 5B are diagrams illustrating a list display of created contents;

FIG. 6 is a flowchart illustrating an example of processing of editing limitation of an outputted content;

FIGS. 7A and 7B are diagrams illustrating a contents list screen;

FIG. 8 is a diagram illustrating the contents list screen;

FIG. 9 is a diagram illustrating the contents list screen;

FIG. 10 is a flowchart illustrating an example of the processing of editing limitation of the outputted content;

FIGS. 11A and 11B are diagrams illustrating a folder storing a content file;

FIGS. 12A and 12B are diagrams illustrating the folder storing the content file; and

FIG. 13 is a diagram illustrating the folder storing the content file.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same reference numerals are provided to the same constituents.

### First Embodiment

### <Overview>

A content creation application described in the present embodiment is an application that designs a poster, a photo album, a photograph layout, or the like by arranging an object such as an image or a text in an editing region on a screen. The content creation application in the present disclosure is applicable to general layout software such as a poster editing application, a photo album editing application, or an object layout application. In the embodiments described below, as a specific example of the content creation application, the poster editing application that is a Web application is described as an example.

As described above, in the content creation application, content data that is “under editing” or “outputted” is saved in the application. For example, “outputted” is a state in which output processing on the content data is done. Specifically, the output processing on the content data is processing executed by a printer 121 and is print processing based on the content data, for example. Note that, the print processing is executed by transmitting the content data to the printer 121, for example. In a case where printing based on the content data is completed by the printer 121, it is assumed that the content data is in a state in which the print processing is done. Note that, the content data in this case may be transmitted from a client terminal 110 to the printer 121 via a server system 140 or may be transmitted from the client terminal 110 to the printer 121 without the server system 140. Additionally, specifically, the output processing on the content data is order processing to order a content expressed by the content data, for example. The order processing is processing for payment to purchase the content expressed by the content data, for example. In a case where the processing for payment is completed, it is assumed that the content data is in a state in which the order processing is done. Moreover, specifically, the output processing on the content data is transmission (upload) processing to transmit (upload) the content data to an apparatus outside the client terminal 110 such as the server system 140 and the printer 121, for example. In a case where the content data is transmitted (uploaded) to the apparatus outside the client terminal 110, it is assumed that the content data is in a state in which the transmission (upload) processing is done. That is, in the content creation application, there are both the content data that is “under editing” and content data that is “outputted” in the application. In this case, although there is the content data that the user wants to save while maintaining the state at which the content data is outputted, there is a possibility that the user inadvertently edits and overwrites and saves the content data. In other words, in some cases, it is impossible to save the content data that the user wants to maintain in the state at which the content data is outputted. Additionally, it is impossible to distinguish the content data that is saved in the state at which the content data is outputted from the content data that is edited again after being outputted (regardless of whether it is purposely), and thus the convenience of the content management for the user is reduced.

In the embodiments described below, an example of suppressing the inadvertent editing of the outputted content data is described. Additionally, an example of facilitating the distinguishing the outputted content from the content that is edited again after being outputted is described. Note that, in the embodiments described below, the content may include both the data included in the content (hereinafter, also referred to as content data) and icon indicating the content.

### <Information Processing System>

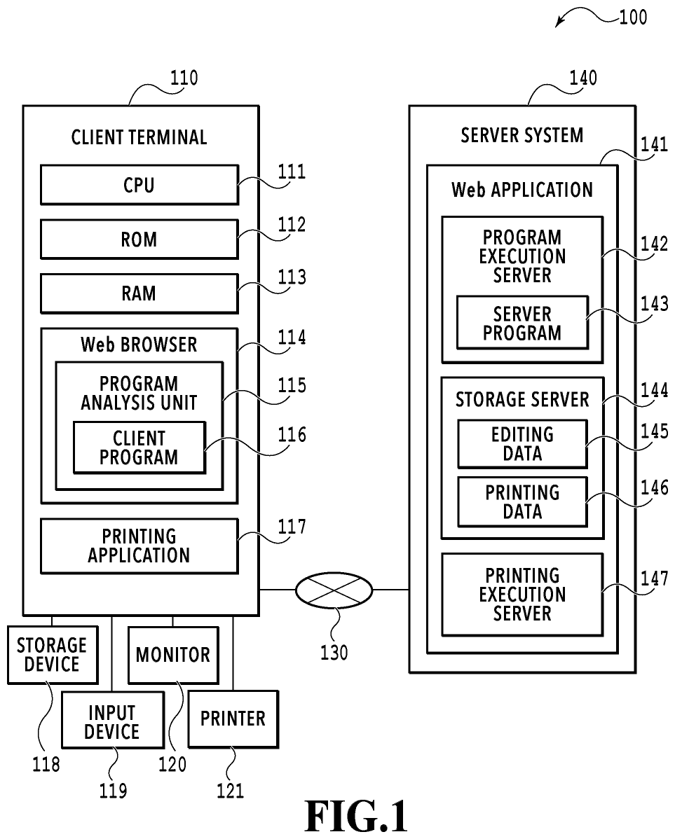

FIG. 1 is a diagram illustrating a configuration of an information processing system 100 in the present embodiment. The information processing system 100 is operated with the client terminal 110 and the server system 140 cooperating with each other via a network 130.

First, a configuration of the server system 140 is described. The server system 140 that performs processing of a server in a Web application 141 includes a program execution server 142, a storage server 144, and a printing execution server 147. The program execution server 142 executes a server program 143 that is a program operated by the server system 140. The storage server 144 saves editing data 145 such as an image file and a printing data file in the Web application 141 and printing data 146. The printing execution server 147 transmits the printing data 146 to a printing application 117 and performs printing. Note that, the program execution server 142, the storage server 144, and the printing execution server 147 may be implemented by physically separated apparatuses or may be implemented by a single apparatus.

Next, a configuration of the client terminal 110 is described. The client terminal 110 is an information processing apparatus and can be formed of a common personal computer or smartphone.

The client terminal 110 includes a CPU 111, a ROM 112, and a RAM 113. Additionally, the client terminal 110 includes an input and output interface (not illustrated) so as to be connected with a storage device 118, an input device 119, a monitor 120, the printer 121, and the network 130 such as the Internet. The CPU 111 is a central processing unit and controls overall the client terminal 110 by executing an operating system (OS) stored in the storage device 118, the ROM 112, or the RAM 113. Additionally, the CPU 111 executes a Web browser 114, the printing application 117, or another program stored in the ROM 112 or the RAM 113 to perform computation based on inputted data and processes and outputs the data. Moreover, the CPU 111 implements each function of the client terminal 110 by controlling each type of hardware. The ROM 112 is a read-only memory and stores each program. The RAM 113 is a random access memory and used as a working memory of the CPU 111; however, a non-volatile RAM can also store each program.

The Web browser 114 browses a Website on the Internet and executes the Web application 141. In general, the Web application 141 is formed of a client program 116 and the server program 143. The entity of the client program 116 is a program such as Hypertext Markup Language (HTML) or JavaScript operated on the Web browser 114. The entity of the server program 143 is a program operated on a Web server.

In a case where the Web application 141 is executed, first, the client terminal 110 receives the client program 116 forming a part of the Web application 141 from the server system 140. Subsequently, a program analysis unit 115 of the Web browser 114 interprets and executes the client program 116 (script language such as HTML or JavaScript), and the Web application 141 is activated. The method of activating the Web application 141 includes a method of activation by inputting a URL to activate the Web browser 114 into the Web application 141. To be more specific, once the URL is inputted into the Web browser 114, the server system 140 transmits the client program 116 forming a part of the Web application 141 to the Web browser 114. Subsequently, the Web browser 114 receives the client program 116 from the server system 140 to execute, and thus the Web application 141 is activated. In other words, in the Web application 141, the Web browser 114 provides an execution instruction via the client program 116 to the server program 143 executed by a not-illustrated CPU on the program execution server 142. To be more specific, the Web browser 114 is configured to output an execution command of the server program 143 to the server system 140 (the program execution server 142) and display a processing result of the server program 143.

The printing application 117 transmits the printing data 146 to the printer 121, which is connected directly to or connected via the network 130 to the client terminal 110, and performs printing.

The printer 121 executes printing based on the printing data created by the information processing system 100. The storage device 118 is a storage device such as an HDD or an SSD that stores image data, a template, and the like. The input device 119 is an input device such as a keyboard or a pointing device that performs input into the information processing system 100. Depending on a mode of the input device, the input device may be a touch panel that is integral with a monitor and receives an input with a direct touch on the monitor. The monitor 120 is a display apparatus that displays image information outputted by the information processing system 100.

Note that, the configuration illustrated in FIG. 1 is merely an example and is not limited to this example. For example, a configuration in which the client terminal 110 includes at least one of the storage device 118, the input device 119, and the monitor 120 may be applicable.

### <Web Application>

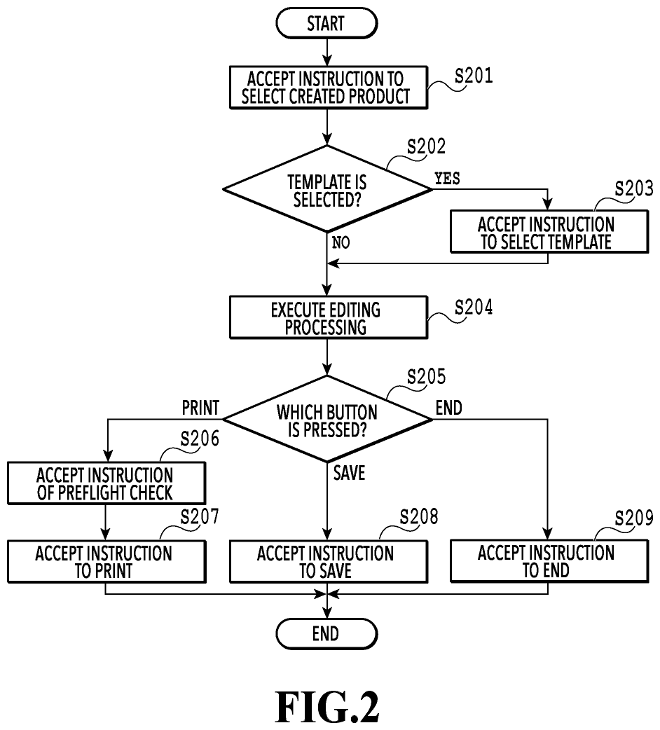

Next, basic processing of the Web application 141 that is performed in the present embodiment is described with reference to FIGS. 2 to 4.

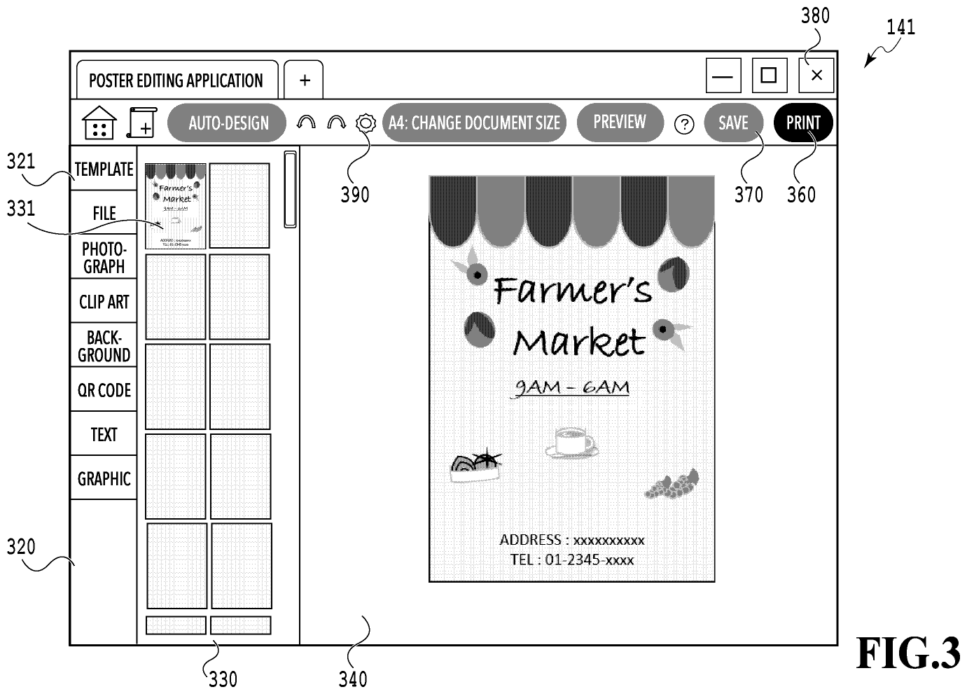

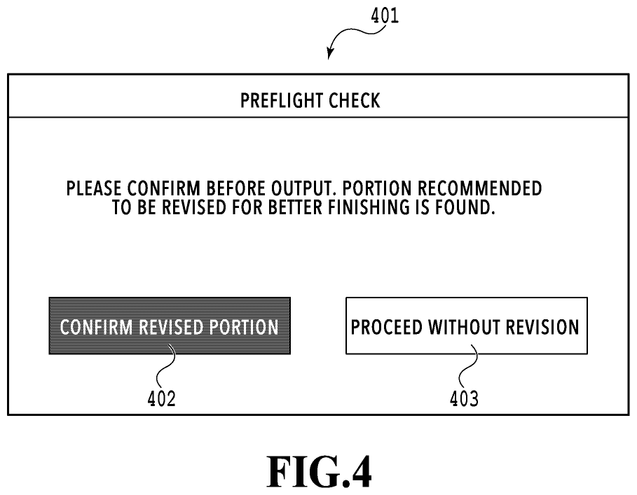

FIG. 2 is a flowchart illustrating an example of processing of the Web application. FIG. 3 is a diagram illustrating an example of a screen in the Web application. FIG. 4 is a diagram illustrating an example of a preflight check screen.

The processing in the flowchart illustrated in FIG. 2 is implemented with the CPU 111 reading out the client program 116 stored in the ROM 112 and the like of the client terminal 110 to the RAM 113 to execute. To be more specific, the processing in the flowchart illustrated in FIG. 2 is processing executed by the CPU 111 of the client terminal 110 including the Web browser 114. That is, the processing is executed by the CPU 111 operating the Web browser 114 with the CPU 111 of the client terminal 110 reading out the client program 116 received from the server system 140 to the RAM 113 to execute. More specifically, the present processing is executed by the Web browser 114 with the program analysis unit 115 in the Web browser 114 interpreting and executing the client program 116 received from the server system 140 by the Web browser 114. That is, the present processing may also be called processing that the client program 116 causes the Web browser 114 and the client terminal 110 to execute. With the Web browser 114 executing the client program 116, the Web application 141 provided by the server system 140 is executed via the Web browser 114.

Note that, a part of or all the functions of steps in FIG. 2 may be implemented by hardware such as an ASIC or an electronic circuit. A sign “S” in description of each processing means that it is a step in the corresponding sequence diagram (hereinafter, the same applies to a flowchart in the present specification). The processing in FIG. 2 is started after the Web browser 114 activates the Web application 141.

In S201, the CPU 111 accepts an instruction to select a created product by the user. Then, the CPU 111 sets a type of the created product (a poster, a flyer, an album, a calendar, or the like) according to an operation by the user. Hereinafter, various types of processing are executed on the content data corresponding to the type set in this process. Additionally, the content data generated and edited in the present processing is data for printing of the created product of the type set in this process. Moreover, hereinafter, description is provided assuming that the poster is selected.

In S202, the CPU 111 determines whether a template is selected according to the operation by the user on the screen of the Web application 141 in FIG. 3. The screen of the Web application 141 illustrated in FIG. 3 is a screen of the Web application 141 that is displayed by the Web browser 114 on the monitor 120. Once the user selects a template selection button 321 in a category selection region 320, the CPU 111 displays a list of templates in a template selection region 330. In a case where the user selects the template from this region, a determination result in S202 is true, and the process proceeds to S203.

In S203, the CPU 111 accepts an instruction to select the template. Then, the CPU 111 generates poster data using the selected template and displays the poster data in an editing region 340. Note that, the poster data is the content data for printing of the poster. FIG. 3 illustrates an example of a case where the user selects a template 331 from the template selection region 330 and sets the layout thereof automatically. In a case where the processing in S203 ends, or if the determination result in S202 is false, the CPU 111 allows the process to proceed to S204.

In S204, the CPU 111 executes editing processing according to an editing operation from the user. The CPU 111 then reflects the editing content on the poster data to display in the editing region 340. A specific example of the editing operation includes adding, moving, size changing, or the like of the object. Once the processing in S204 ends, the CPU 111 allows the process to proceed to S205.

Note that, the Web application 141 has an environment setting function that allows the user to switch a display in a case of performing an editing work according to the preference. An example of the setting content includes display setting of a trimming region, display setting of a grid or a guide line as a guide for the arrangement in the editing region 340, or the like. An environment setting button 390 is used for the user to switch the display in a case of performing the editing work according to the preference.

In S205, the CPU 111 determines which button is pressed on the screen illustrated in FIG. 3 according to the operation by the user. If a determination result of the present step is “print”, in other words, if the pressing of a print button 360 is detected, the CPU 111 allows the process to proceed to S206. In S206, the CPU 111 accepts an instruction of preflight check before printing. Here, the preflight check is a function to analyze previously whether the object is properly arranged for the content data before being outputted and to prompt a revision from the user as needed. Once receiving the instruction of the preflight check, the CPU 111 analyzes the content data, and in a case where there is no portion that needs the revision, the CPU 111 ends the processing in S206. On the other hand, in a case where a portion that needs the revision is found, the CPU 111 displays a preflight check screen 401 illustrated in FIG. 4.

The preflight check screen 401 in FIG. 4 is a screen displayed in a display region of the monitor 120. The preflight check screen 401 in FIG. 4 includes a button 402 to “confirm a revised portion” and a button 403 to “proceed without revision”. The button 402 to “confirm a revised portion” and the button 403 to “proceed without revision” are operation regions to accept the selection by the user. In a case where the user presses the button 402 to “confirm a revised portion” via the preflight check screen 401, the CPU 111 accepts the user input, the display screen transitions to the editing region 340, and the revision of the portion from the user is prompted. On the other hand, in a case where the user presses the button 403 to “proceed without revision” via the preflight check screen 401, the CPU 111 accepts the user input and ends the processing in S206. Note that, although the preflight check is executed in the Web application 141 as an example in the present embodiment, it is not limited to this example. The preflight check may be executed in the printing application 117 that performs processing in a subsequent stage. Once the processing in S206 ends, the CPU 111 allows the process to proceed to S207. In S207, the CPU 111 accepts the instruction of printing and transmits the content data to the printing application 117.

If the determination result in S205 is “save”, in other words, if the pressing of a save button 370 is detected, the CPU 111 allows the process to proceed to S208. In S208, the CPU 111 executes processing of saving the content data. If the determination result in S205 is “end”, in other words, if the pressing of an end button 380 is detected, the CPU 111 allows the process to proceed to S209. In S209, the CPU 111 accepts an instruction to end the application.

Once the processing in any one of S207, S208, and S209 ends, the CPU 111 accepts the ending of the content editing processing, and the sequence of processing is completed. Note that, although it is not illustrated, in a case where a button other than print, save, and end is pressed in S205, processing according to the pressed button may be performed, and thereafter, the determination in S205 may be performed subsequently. The above is an overview of the basic processing of the Web application 141.

### <Contents List of Web Application>

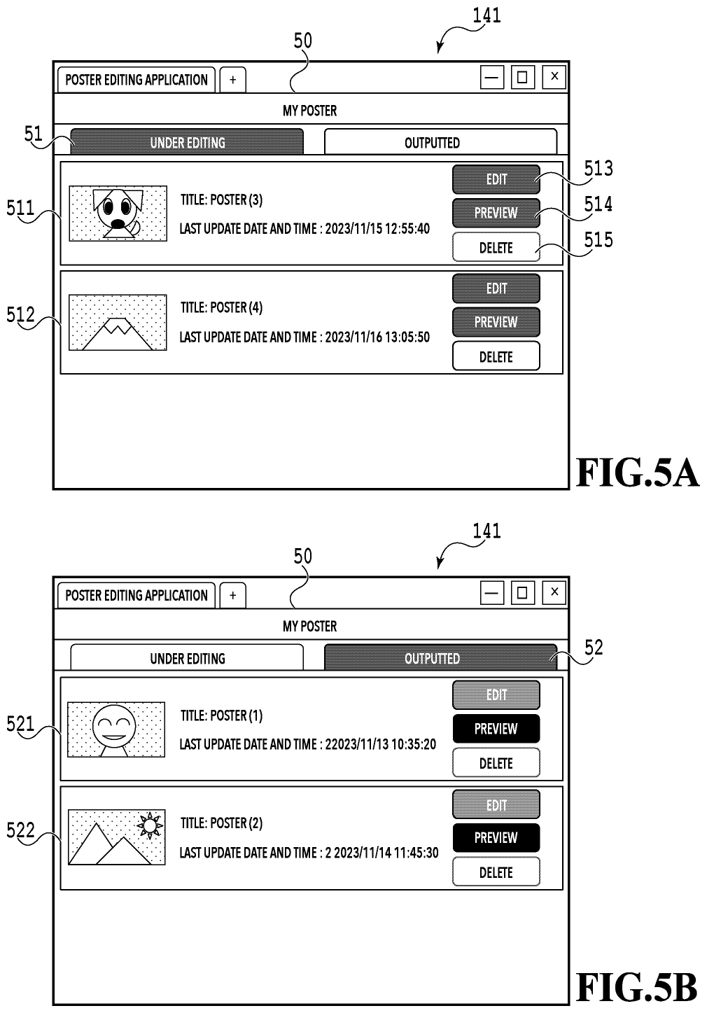

FIGS. 5A and 5B are diagrams illustrating a list display of the created contents in the Web application 141 of the present embodiment. Each screen in FIGS. 5A and 5B is a screen displayed in the display region of the monitor 120. In a case where the user edits or outputs (prints, orders, transmits, uploads, and the like) the content by using the Web application 141, the CPU 111 saves the data of the content and displays the data on a contents list screen 50 illustrated in FIGS. 5A and 5B. FIG. 5A is a screen of a list display of icons 511 and 512 indicating the content data that is “under editing”. FIG. 5B illustrates a screen of a list display of icons 521 and 522 indicating the content data that is “outputted”.

As illustrated in FIGS. 5A and 5B, on the Web application 141 in the present embodiment, the icon indicating the content data that is “under editing” and the icon indicating the content data that is “outputted” are each categorized and displayed. In addition, it is possible to switch the display of the contents list with the user selecting either one of an “under editing” tab 51 in FIG. 5A and an “outputted” tab 52 in FIG. 5B. That is, the Web application 141 in the present embodiment displays in the display region a graphical user interface in which the icon of the content that is under editing and the icon of the content that is outputted are categorized in different regions, respectively. With each icon, a representative graphic, a title, the last update date and time, and the like of the content data are displayed together so as to facilitate the distinguishing of the content by the user. Note that, in a case where the content data is data for the printing of the content corresponding to a printed product of one page such as a poster or a flyer, the representative graphic of the content data is a whole image expressed by the content data, for example. Note that, in a case where the content data is data for the printing of the content corresponding to a printed product of multiple pages such as an album and a calendar, for example, the representative graphic of the content data is any one of the images expressed by the content data, which is a cover, for example. Note that, it is possible to set which content to be printed the content data is for by the processing in S201 that is executed in a case of creating and editing the content data.

As indicated by a reference numeral provided in FIG. 5A, on the contents list screen 50, an edit button 513, a preview button 514, and a delete button 515 are arranged to each content correspondingly. Once the user presses the edit button 513, the preview button 514, or the delete button 515 of the content, the CPU 111 detects the pressing of the button and executes each processing. For example, once detecting the pressing of the edit button 513, the CPU 111 transitions to an editing screen of the content data. Once detecting the pressing of the preview button 514, the CPU 111 displays a preview of the content. Once detecting the pressing of the delete button 515, the CPU 111 deletes the content. That is, the CPU 111 deletes the content data and the corresponding icon.

Note that, although a configuration in which the icons indicating the contents are displayed separately based on the status by using the “under editing” tab 51 and the “outputted” tab 52 is applied in the present embodiment, it is not limited thereto. A configuration in which icons of all the contents are mixed and displayed on the single contents list screen 50 may be applicable. The above is an overview of the list display of the contents of the Web application.

### <Editing Limitation of Outputted Content Data>

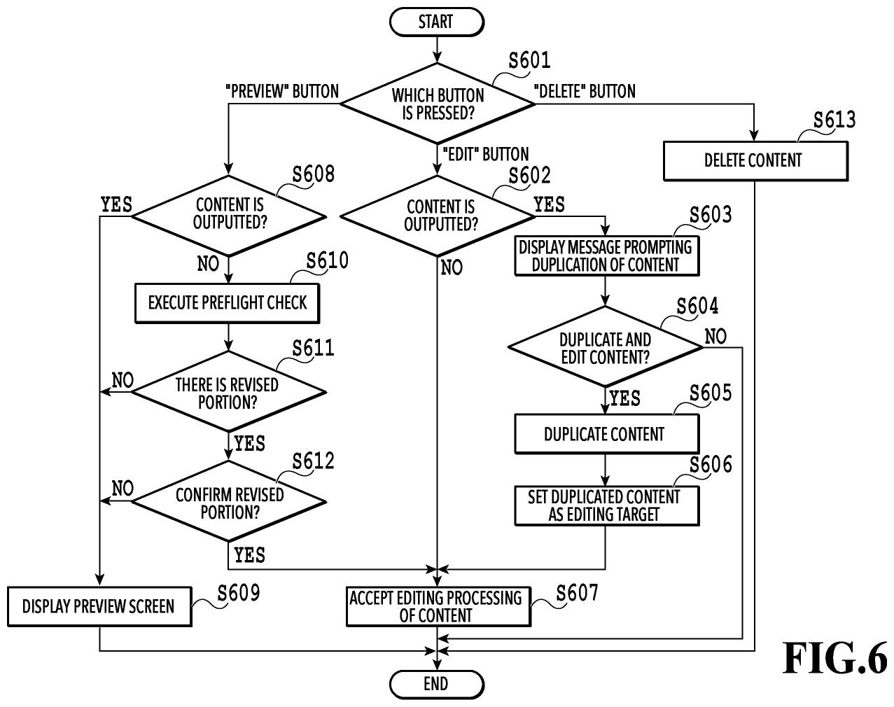

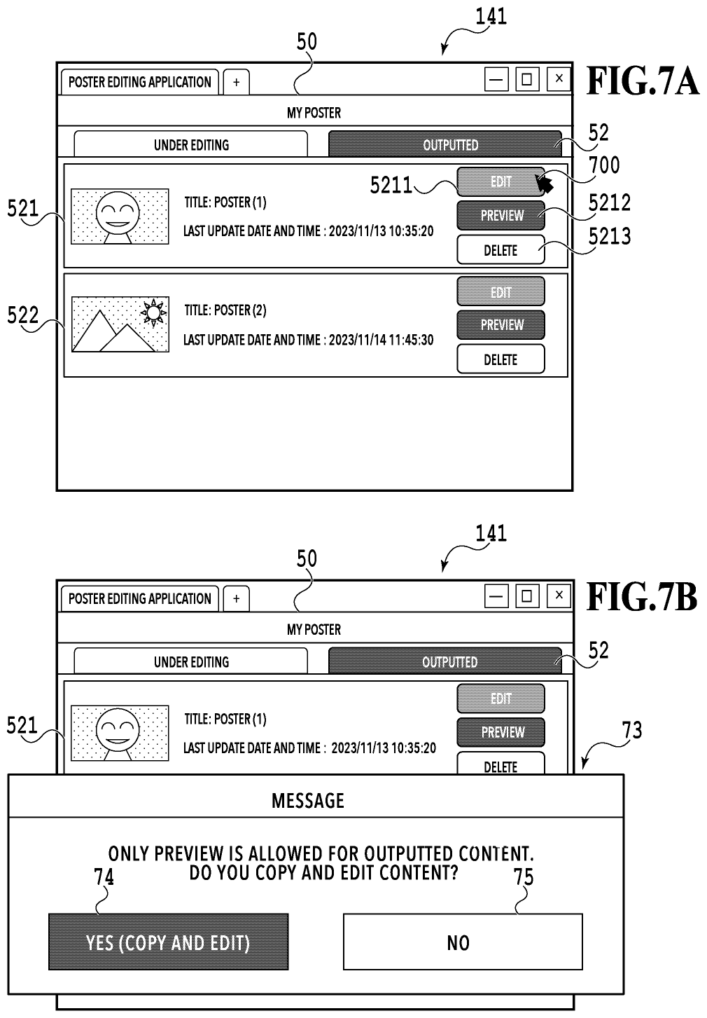

FIG. 6 is a flowchart illustrating an example of processing of editing limitation of the outputted content. FIGS. 7A, 7B, 8, and 9 are diagrams illustrating the contents list screen 50 in the present embodiment, which is a screen displayed in the display region of the monitor 120. Hereinafter, the editing limitation of the outputted content performed in the present embodiment is described with reference to FIGS. 6 to 9.

In the present embodiment, once the editing operation on the outputted content by the user is detected, limitation processing is performed so as to prompt the user to duplicate the content and set the duplicated content as an editing target instead of the outputted content. In the present embodiment, as illustrated in FIG. 7A, it is assumed that there are the icons 521 and 522 of the content data that is “outputted” on the contents list screen 50. In addition, a case in this state where the pressing of an “edit” button 5211 by the user using a cursor 700 on the icon 521 of the content data is detected is used as an example for description. That is, description is provided by using a case where the editing operation on the content data indicated by the icon 521 is accepted from the user as an example.

As with the processing described in FIG. 2, processing in the flowchart illustrated in FIG. 6 is implemented with the CPU 111 reading out the client program 116 stored in the ROM 112 and the like of the client terminal 110 to the RAM 113 to execute. To be more specific, the processing in the flowchart illustrated in FIG. 2 is the processing executed by the CPU 111 of the client terminal 110 including the Web browser 114. That is, with the Web browser 114 executing the client program 116, the Web application 141 provided by the server system 140 is executed in the Web browser 114. The disclosure of the processing in the flowchart illustrated in FIG. 6 is triggered with the user detecting the editing operation on the content. Specifically, triggered by the pressing of any one of the edit button, the preview button, or the delete button on the contents list screen 50, the processing is started.

In S601, the CPU 111 detects which operation button is pressed for the target content. As described above, in the present example, the pressing of the “edit” button 5211 in FIG. 7A is detected. In a case where the pressing of the “edit” button 5211 is detected, the CPU 111 allows the process to proceed to S602.

In S602, the CPU 111 determines whether the content that is a processing target for which the “edit” button 5211 is pressed is outputted. For example, in the present embodiment, since the content data indicated by the icon 521 that is the processing target is the content displayed in the “outputted” tab 52 in FIG. 7A, the determination result in S602 is true. If the determination result in S602 is true, the CPU 111 allows the process to proceed to S603. If the determination result in S602 is false, the CPU 111 allows the process to proceed to S607.

In S603, the CPU 111 displays a message prompting the duplication of the content. Specifically, a message dialogue 73 as illustrated in FIG. 7B is displayed. The message dialogue 73 includes a message indicating that only a preview is allowed for the outputted content. Additionally, the message dialogue 73 includes a message asking whether to copy and edit the content.

Subsequently, in S604, the CPU 111 determines whether the user duplicates and edits the content that is the processing target. Specifically, whether the pressing of a “YES (copy and edit)” button 74 in the message dialogue 73 in FIG. 7B is accepted or the pressing of a “NO” button 75 is accepted is determined. If the pressing of the “YES (copy and edit)” button 74 is accepted, the determination result in S604 is true. If the pressing of the “NO” button 75 is accepted, the determination result in S604 is false. If the determination result in S604 is true, the CPU 111 allows the process to proceed to S605. If the determination result in S604 is false, the CPU 111 ends the processing in the flowchart illustrated in FIG. 6.

In S605, the CPU 111 duplicates the content that is the processing target without deleting the content that is the processing target from the “outputted” tab 52. Specifically, the CPU 111 duplicates the content data indicated by the icon 521 displayed in the “outputted” tab 52. In this process, the CPU 111 duplicates also an icon corresponding to the icon 521. Note that, the duplication of the icon may be performed by duplicating the icon 521 directly or by generating a new icon indicating the content data from the duplicated content data. Thus, in S605, the content is duplicated without deleting the content that is the processing target from the “outputted” tab 52. Therefore, in a case where the “outputted” tab 52 is displayed again after the processing in the present flowchart ends, the icon 521 of the content that is an original for the duplication is still displayed.

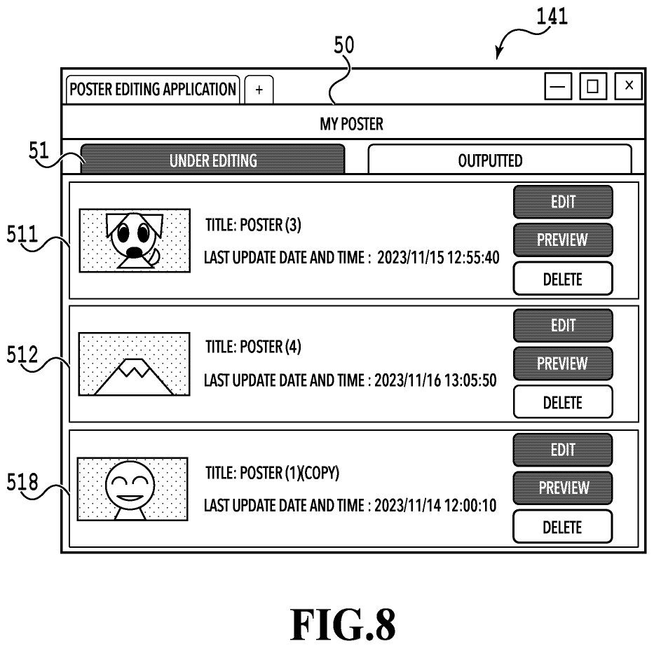

Subsequently, in S606, the CPU 111 sets the duplicated content as the editing target. Thus, the “under editing” tab 51 displays an icon 518 of the duplicated content as illustrated in FIG. 8. FIG. 8 is a diagram illustrating a screen displayed in the “under editing” tab 51 after the duplicated content is set as the editing target. Note that, in the processing in S606 in this case, the “under editing” tab 51 may not be displayed. In a state in which it is after the present processing and the content data indicated by the icon 518 is not outputted yet, if an operation to display the “under editing” tab 51 is performed by the user, the “under editing” tab 51 as illustrated in FIG. 8 is displayed. After the duplicated content is set as the editing target, the CPU 111 transitions to the editing screen to edit the duplicated content. Subsequently, the CPU 111 allows the process to proceed to S607.

In S607, the CPU 111 accepts the processing of editing the content. For example, in a case where the processing in S607 is performed after S606, the CPU 111 accepts the processing of editing the content data of the duplicated content. On the other hand, in S607 performed after it is determined in S602 that the content is not outputted, the CPU 111 accepts the processing of editing the content data that is the processing target. Once the processing of editing the content data is completed, the CPU 111 ends the processing in the flowchart in FIG. 6.

For example, in a case where the processing in S607 ends after S606, the contents list screen 50 as illustrated in FIG. 8 is obtained. As indicated by the icon 518 in FIG. 8, the content after the duplication is displayed in the “under editing” tab 51. That is, it is possible to accept the “editing” operation by the user for the content after the duplication (corresponding to the icon 518) as a content different from the outputted content (corresponding to the icon 521). The above is a flow of the sequence of processing in a case where the “edit” button is pressed in the present embodiment.

Note that, in the example in FIG. 8, the content after the duplication (corresponding to the icon 518) is in a state in which the editing processing is performed by the user and the details thereof is saved. Therefore, the last update date and time of the content data after the duplication indicated by the icon 518 is different from the last update date and time of the content data (the icon 521) in FIG. 7A that is the content before the duplication. With the confirmation the last update date and time of each content, the user can recognize that the content indicated by the icon 518 is the content on which some kind of editing is performed after the content data of the content indicated by the icon 521 is outputted.

Note that, although an example in which a step of displaying the message prompting the duplication of the content in S603 and determining whether to duplicate and edit the content in S604 is described in the present example, it is not limited thereto. A configuration in which the processing in S603 and S604 may be skipped and the processing in S605 is performed may be applicable.

Next, a case where a “preview” button 5212 is pressed on the contents list screen 50 is described.

In S601, the CPU 111 detects which operation button is pressed for the content that is the processing target. If the “preview” button 5212 in FIG. 7A is pressed, the CPU 111 allows the process to proceed to S608.

In S608, the CPU 111 determines whether the content that is the processing target is outputted. If the content that is the processing target is not outputted, the CPU 111 allows the process to proceed to S610, and if the content that is the processing target is outputted, the CPU 111 allows the process to proceed to S609.

In S610, the CPU 111 executes the preflight check on the content that is the processing target. As described above, the preflight check is a function to analyze previously whether the object is properly arranged for the content data before being outputted and to prompt a revision from the user as needed. Once the instruction of the preflight check is accepted, the CPU 111 analyzes the content data and branches the processing as the processing in and after S611 described below depending on whether there is the revised portion.

In S611, the CPU 111 determines whether there is the portion to be revised by the preflight check. If the determination result in S611 is true, in other words, if there is the portion that should be revised, the CPU 111 allows the process to proceed to S612.

In S612, the CPU 111 displays the preflight check screen 401 illustrated in FIG. 4 and accepts the selection by the user that indicates whether to confirm the revised portion. If the determination result in S612 is true, in other words, if the confirmation of the revised portion by the user is accepted, the CPU 111 allows the process to proceed to S607. In S607, the CPU 111 accepts the processing of editing the content. On the other hand, if the determination result in S612 is false, in other words, if the confirmation of the revised portion by the user is not accepted, the CPU 111 allows the process to proceed to S609.

A case where the process proceeds to S609 includes a case where there is no portion to be revised by the preflight check and a case where the selection indicating not to confirm the revised portion is accepted while the content that is the processing target is not outputted. Additionally, a case where the process proceeds to S609 includes also a case where the content that is the processing target is outputted.

In S609, the CPU 111 displays a preview screen of the content that is the processing target. For example, in a case where the content that is the processing target is the outputted content, the preview screen of the outputted content is displayed such that the user can confirm a layout and the like at the time of being outputted. Here, as the processing in which the determination result in S608 is true and the process proceeds to S609, the CPU 111 does not execute the preflight check on the outputted content in the present embodiment. In other words, the CPU 111 performs processing of avoiding the transition of the outputted (for example, printed) content to the editing screen based on the determination result of the preflight check. Thus, since the transition to the editing screen to edit the outputted content can be suppressed, it is possible to suppress the inadvertent editing of the outputted content by the user.

Additionally, in S611, if there is no portion to be revised by the preflight check and if the selection indicating not to confirm the revised portion is accepted, the CPU 111 displays the preview screen of the content that is the processing target. Once the processing in S609 ends, the CPU 111 ends the processing in the flowchart illustrated in FIG. 6. The above is a flow of the sequence of processing in a case where the “preview” button is pressed in the present embodiment.

Next, a case where the “delete” button is pressed on the contents list screen 50 is described.

In S601, the CPU 111 detects which operation button is pressed for the target content. In a case where a “delete” button 5213 in FIG. 7A is pressed, the CPU 111 allows the process to proceed to S613. In S613, the CPU 111 deletes the content that is the processing target. That is, the CPU 111 deletes the content data that is the processing target and the corresponding icon. The CPU 111 then ends the processing in the flowchart illustrated in FIG. 6. The above is a flow of the sequence of processing in a case where the “delete” button in the present embodiment is pressed.

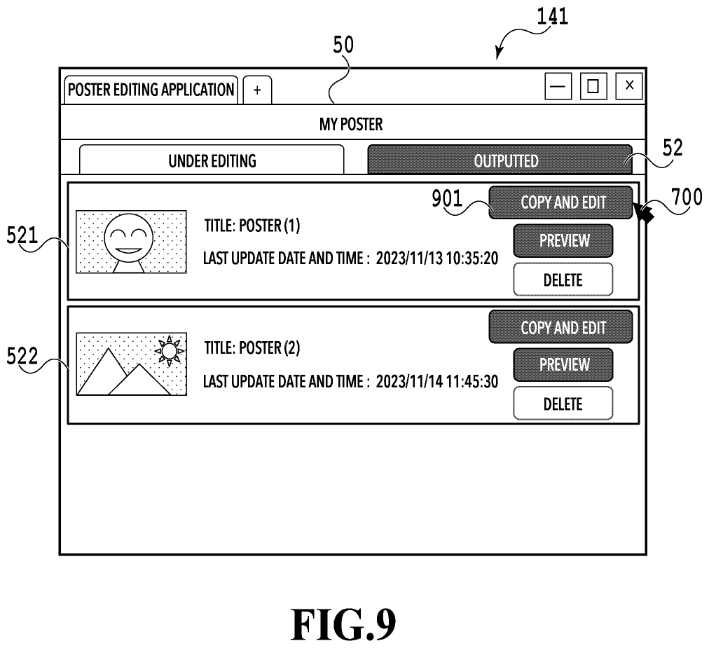

Note that, although an example in which the duplication of another content is prompted in a case where the pressing of the “edit” button for the outputted content is detected is described in the present embodiment, it is not limited to this example. For example, as illustrated in FIG. 9, a “copy and edit” button 901 may be displayed for the outputted content instead of the “edit” button. Then, it is possible to apply a configuration to perform the processing similar to that in a case where the “edit” button is pressed in the above-described example in a case where the “copy and edit” button 901 is pressed. As illustrated in FIG. 9, the contents list screen may be formed as a UI indicating that the processing of duplication is performed in a case where the outputted content is edited. Thus, it is possible to suppress the inadvertent editing of the outputted content.

In the example in the flowchart illustrated in FIG. 6, an example in which the preflight check of the outputted content is not performed in a case where “preview” is instructed is described. Although it is not illustrated, in addition to a case of “preview”, for example, in a case where “print” is instructed, a similar configuration in which the CPU 111 does not perform the preflight check of the outputted content may be also applied.

Additionally, although a case where there is one user is assumed and described in the present embodiment, the present embodiment is useful also in a case where there are multiple users. For example, a case where the content data is co-edited to edit a design by multiple people is assumed. In this case, information of the user who outputs the content data may be displayed on the contents list in the “outputted” tab. According to the above-mentioned configuration, it is possible to clearly show which user outputs the content and when. Additionally, there may be a case where the multiple users edit the same content simultaneously. In the above-mentioned case, once a first user executes the output processing, the CPU 111 displays the content at a timepoint in which the first user executes the output processing and the information of the first user on the contents list in the “outputted” tab. On the other hand, a configuration in which, in a case where a second user who is currently editing the content executes saving after the editing is completed, for example, the second user is prompted to duplicate another content as described in the present embodiment may be applicable. Thus, in a case where the processing of the present embodiment is applied to multiple people, it is possible to use the processing as management of the work history of each person.

As described above, in the present embodiment, it is possible to suppress the inadvertent editing of the outputted content. That is, in the present embodiment, in a case where the editing operation on the outputted content is detected, the editing of the outputted content is not allowed, and the duplication as another editable content is prompted. Thus, it is possible to suppress the inadvertent editing of the outputted content by the user.

### Second Embodiment

In the first embodiment, an example in which the content data is saved in the application is described. That is, a mode in which the content data is saved as a part of the data of the application is described. In the present embodiment, an example in which the saving of the content data is different from the first embodiment is described. Specifically, in the present embodiment, an example in which the content data is a content file saved outside the application is described. That is, in the present embodiment, an example in which the content may include the content data and the icon of the content file indicating the content data is described. The content file is file-managed under a file system of a common OS. Additionally, the content file is displayed by using a predetermined icon in the file system of the OS. In the present embodiment, an example in which it is possible to suppress the inadvertent editing of the outputted content even in a case of using the above-mentioned content file is described. Since the basic configuration in the present embodiment may be similar to the example described in the first embodiment, a different point is mainly described below.

### <Editing Limitation of Outputted Content File>

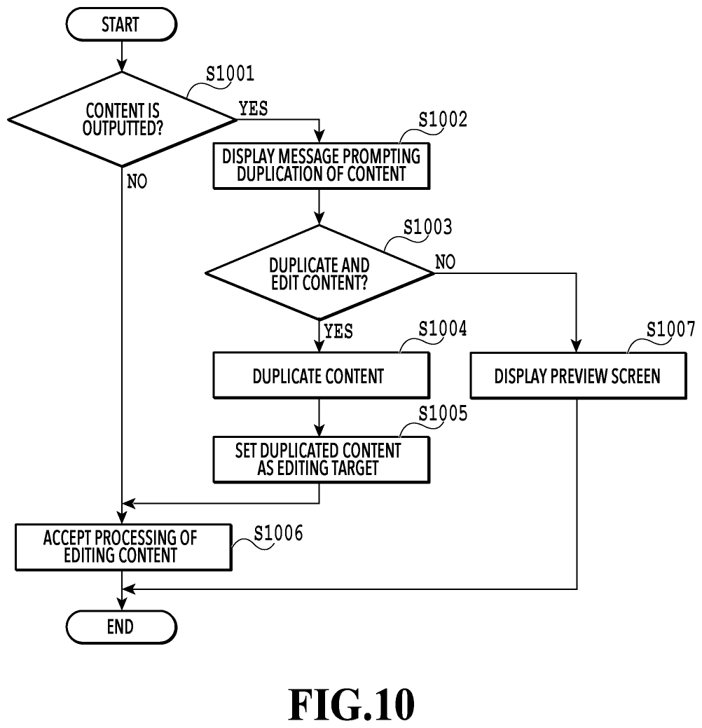

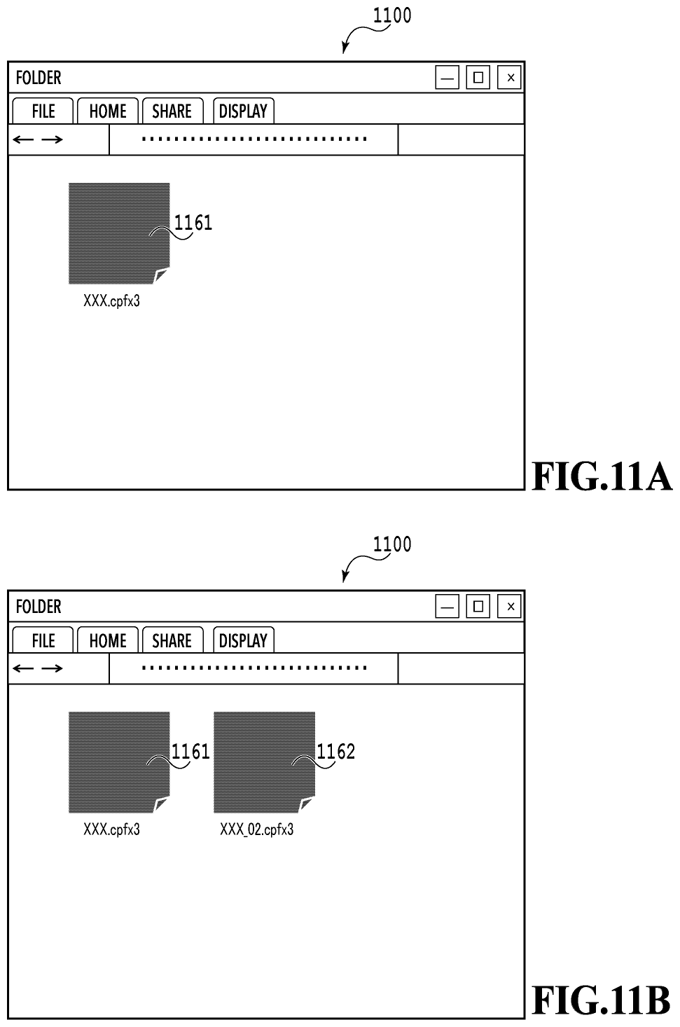

Hereinafter, editing limitation of the outputted content file in the present embodiment is described with reference to mainly FIGS. 10 to 13. FIG. 10 is a flowchart illustrating an example of processing of editing limitation of the outputted content. FIGS. 11A, 11B, 12A, 12B, and 13 are diagrams each illustrating a folder storing the content file, which is a screen displayed in the display region of the monitor 120.

In the present embodiment, in a case where the content file saved in an external folder and the like is the outputted content file, editing of the outputted content file is not allowed, and the processing of prompting the duplication of another editable content file is performed.

Note that, the outputted content file in the present embodiment is a file in which the content is edited by the user by using the content creation application, and thereafter processing such as printing, ordering, transmitting, or uploading is executed. The information indicating whether the content file is outputted is held by the content file itself as attribute information. In other words, in a case where the output operation such as printing is executed by the user, the content file holds the information indicating that the own file is outputted as the attribute information. To be more specific, the application opens the content file of the content under editing and performs layout editing. Then, in a case where there is the output instruction from the user, the information indicating that the file is outputted is written in the attribute information of the opened content file. In this process, in a case where the latest editing content is not overwritten and saved in the content file, the content file is overwritten and saved with the latest (that is, at a time point of being outputted) content.

The content file is associated with an application that uses the content file by a function of the OS. In the file system of the OS, once an instruction to open the content file is inputted, the OS activates the application associated with the content file and allows for the operation such as editing or outputting in the application. A format (extension) of the content file is different depending on the application used, and in the present embodiment, poster data of a “.cpfx3” format is described as an example.

The processing in the flowchart illustrated in FIG. 10 is implemented with the CPU 111 reading out the client program 116 stored in the ROM 112 and the like of the client terminal 110 to the RAM 113 to execute. That is, as with the example described in the processing in FIG. 6, the processing in FIG. 10 is processing executed by the Web browser 114 activated by the CPU 111. With the Web browser 114 executing the client program 116, the Web application 141 provided by the server system 140 is executed on the Web browser 114.

In the present embodiment, as illustrated in FIG. 11A, a state in which a storage folder 1100 of the content file includes a first content file 1161 of “outputted” is described as an example. The storage folder 1100 of the content file is displayed by the OS. In the present embodiment, a case where it is detected that the first content file 1161 of “outputted” stored in the storage folder 1100 is file-opened (edited) by the user operation is described as an example. Note that, as an example of the user operation of file-opening, in the present embodiment, an operation in which the user double-clicks the content file is performed. Once the double-click operation of the content file by the user is accepted, the OS activates the content creation application associated with the content file. Then, the activated application starts editing of the content file that accepts the double-click operation. Note that, as with the first embodiment, “outputting” of the “outputted” content herein is a collective term of printing, ordering, transmitting, or uploading, or processing that is equivalent thereof. Additionally, the file extension “.cpfx3” in FIGS. 11 to 13 is an extension of the poster data and is an example of the content file.

In a case where the editing operation (file-open) on the content file by the user is detected and the application is activated, the CPU 111 starts the processing in FIG. 10.

In S1001, the CPU 111 determines whether the content that is the processing target is outputted. As described above, the CPU 111 determines whether the content that is the processing target is outputted with reference to the attribute information of the content file. In the present embodiment, the first content file 1161 (XXX.cpfx3) that is the processing target in FIG. 11A is the content file including the information indicating that the file is outputted in the attribute information as described above. If the content that is the processing target is outputted, the CPU 111 allows the process to proceed to S1002, and if the content that is the processing target is not outputted, the CPU 111 allows the process to proceed to S1006.

In S1002, the CPU 111 displays the message prompting the duplication of the content. Specifically, the message dialogue 73 as illustrated in FIG. 7B is displayed.

Subsequently, in S1003, the CPU 111 determines whether the user duplicates and edits the content that is the processing target. Specifically, the CPU 111 determines whether the pressing of the “YES (copy and edit)” button 74 in the message dialogue 73 in FIG. 7B is accepted or the pressing of the “NO” button 75 is accepted. If the pressing of the “YES (copy and edit)” button 74 is accepted, it is determined that the user duplicates and edits the content that is the processing target, and the CPU 111 allows the process to proceed to S1004. If the pressing of the “NO” button 75 is accepted, it is determined that the user does not duplicate and edit the content that is the processing target, and the CPU 111 allows the process to proceed to S1007.

In S1004, the CPU 111 duplicates the content that is the processing target. In this duplication processing, the icon of the content file and the content data indicated by the content file are duplicated. Specifically, as illustrated in FIG. 11B, the CPU 111 duplicates the first content file 1161 (XXX.cpfx3) and generates a second content file 1162 (XXX_02.cpfx3). After S1004, the CPU 111 allows the process to proceed to S1005.

In S1005, the CPU 111 sets the second content file 1162 (XXX_02.cpfx3) generated by the duplication as the editing target. The CPU 111 then opens the second content file 1162 and transitions to a screen to edit the content of the second content file 1162. After S1005, the CPU 111 allows the process to proceed to S1006.

In S1006, the CPU 111 accepts the processing of editing the content. For example, in a case the process proceeds to S1006 after S1005, the CPU 111 accepts the editing processing of the second content file 1162 (XXX_02.cpfx3) generated by the duplication. In other words, the second content file 1162 (XXX_02.cpfx3) after the duplication can accept the “editing” operation by the user as a content file different from the outputted first content file 1161 (XXX.cpfx3).

Note that, as described above, it is a state in which the attribute information of the first content file 1161 includes the information indicating that the file is outputted. Therefore, in a case where the first content file 1161 is duplicated directly, the attribute information including the information indicating that the file is outputted is also duplicated directly. In other words, there is a possibility that it is determined in the subsequent processing that the file is outputted although outputting is not performed for the second content file 1162 after the duplication. Therefore, in the present embodiment, control to prevent the duplication of the attribute information may be performed in the duplication in S1004. Alternatively, after the second content file 1162, which is after the duplication including the attribute information, is generated, the CPU 111 may perform processing of deleting the attribute information related to the information indicating that the file is outputted.

Next, processing in a case where it is determined in S1003 that the first content file 1161 (XXX.cpfx3) is not duplicated and edited is described. In S1007, the CPU 111 displays a preview screen of the first content file 1161 (XXX.cpfx3). In other words, the CPU 111 allows the user to only browse the first content file 1161 (XXX.cpfx3). Thus, it is possible to suppress the inadvertent editing of the content file while allowing the user to confirm the details of the content file. Once the processing in S1007 or the processing in S1006 is completed, the CPU 111 ends the processing of the flowchart illustrated in FIG. 10.

Once the processing of editing the content after S1004 and S1005 is completed, the storage folder 1100 of the content file as illustrated in FIG. 11B is obtained. The above is a flow of the sequence of processing of the present embodiment.

Note that, although the content file outputted to the outside via the printer 121 and the like illustrated in FIG. 1 is applicable as the processing target file as described above in the present embodiment, it is not limited thereto. Specifically, the present embodiment is also applicable to the content file outputted as another file inside the client terminal 110 in FIG. 1.

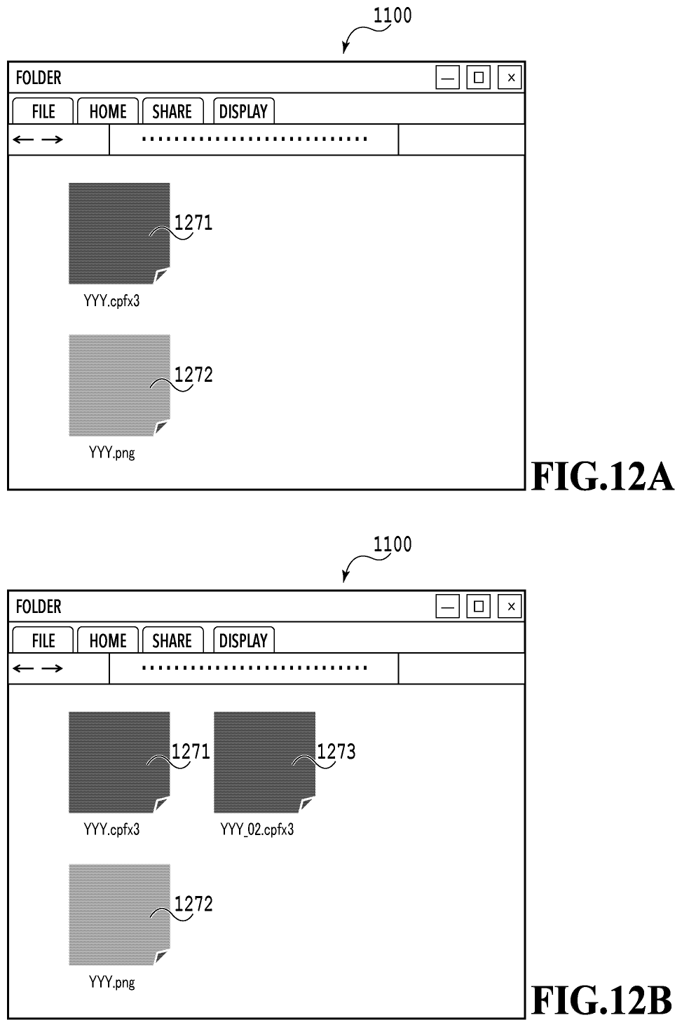

Description is provided by using a third content file 1271 (YYY.cpfx3) in FIG. 12A as an example. A case where the editing work of the third content file 1271 (YYY.cpfx3) is completed by the user and thereafter the content file is outputted as another file 1272 (YYY.png) of another format (here, a PNG format) is assumed. The other file 1272 is an image file indicating the details of the content indicated by the third content file 1271, for example. Thus, in a case where the other file 1272 is outputted, the CPU 111 may perform processing of suppressing the inadvertent editing of the third content file 1271 (YYY.cpfx3) that is the original data. That is, triggered by the outputting of the other file 1272, the CPU 111 generates a fourth content file 1273 (XXX_02.cpfx3) by duplicating the outputted third content file 1271 (YYY.cpfx3) as illustrated in FIG. 12B. Then, the fourth content file 1273 is opened, and the editing screen by the user for the content of the fourth content file 1273 is accepted. With the configuration as mentioned above, it is possible to suppress the inadvertent editing of the outputted content file even in a case where the other file is outputted to the inside of the client terminal 110.

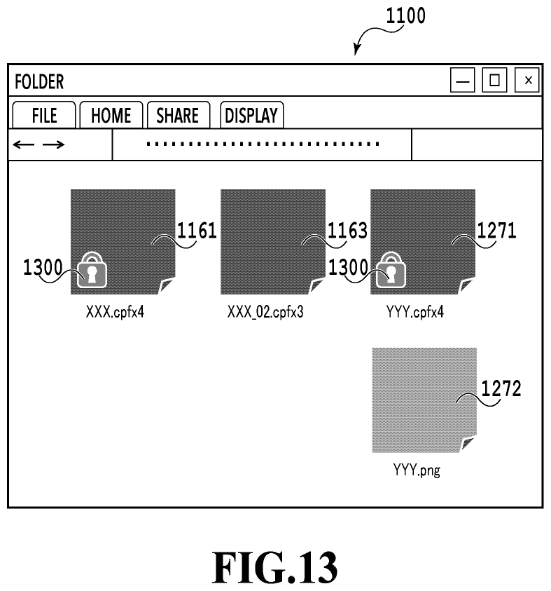

Additionally, it is also possible to visually display whether the content file in the storage folder 1100 is outputted. For example, as illustrated in FIG. 13, the CPU 111 may display an outputted mark 1300 on the outputted first content file 1161 (XXX.cpfx4) and third content file 1271 (YYY.cpfx4). Thus, the user can perceive that only the browsing is allowed. In this case, for example, as illustrated in FIG. 13, the extension of the outputted content file is set as “cpfx4” that is an extension different from “cpfx3”. In this process, in the association of the extension in the OS, an application icon including the outputted mark 1300 is associated with the displayed icon of the extension “cpfx4”. Thus, in the file system in the OS, the user can perceive that only the browsing is allowed.

Thus, it is possible to implement switching of the displaying of the outputted mark 1300 based on the type of the extension. Note that, since the processing of allowing for the duplication and editing of the other second content file 1162 (XXX.cpfx3) in a case where the outputted first content file 1161 (XXX.cpfx4) is file-opened is similar to the above-described processing, description is omitted.

As described above, in the present embodiment, in a case where the editing operation on the outputted content file is detected, the editing of the outputted content file is not allowed, and the duplication as the other editable content file is prompted. Thus, it is possible to suppress the inadvertent editing of the outputted content file.

### Other Embodiments

The function of the Web application 141 described in each of the first embodiment and the second embodiment may have a mode in which the single Web application 141 has the functions of both the first and second embodiments. Alternatively, a first Web application having the function described in the first embodiment and a second Web application having the function described in the second embodiment may be provided separately. Additionally, the information processing system may include only the first Web application or only the second Web application.

Additionally, although an example in which each processing is executed by using the Web application 141 is described in the above-described embodiment, the mode of the Web application may not be applied. That is, an aspect in which the processing of each embodiment described above is executed by using a native application installed on the client terminal 110 that is the information processing apparatus may be applicable.

Moreover, the application to which the idea of the present disclosure is applicable is not limited to a poster editing application. For example, the present disclosure is applicable to general content creation software such as a layout editing application, an album editing application, or an image editing application that newly arranges the object data.

Furthermore, although an example in which a default name showing that it is a duplicated file is provided as a data name (a file name) of the duplicated data is described in each embodiment described above, it is not limited thereto. It is possible to perform control such that the user provides an arbitrary name.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-031958, filed Mar. 4, 2024, which is hereby incorporated by reference wherein in its entirety.

What is claimed is:

1. A control method of an information processing apparatus, comprising:
generating content data;
editing the content data based on a user operation;
outputting the content data on which the editing is performed;
displaying a first region indicating a first list, which is a list of the content data that is not outputted yet;
displaying a second region indicating a second list, which is a list of the content data that is outputted already;
displaying a first editing screen to edit first content data in a case where the first content data is selected from the first list;
displaying a second editing screen to edit third content data obtained by duplicating second content data in a case where the second content data is selected from the second list;
performing control to maintain a state in which the second content data is included in the second list indicated by the second region displayed after the second editing screen is displayed even in a case where the second content data is selected from the second list; and
performing control to newly add the third content data to the first list displayed after an operation to save the third content data without outputting is performed on the second editing screen.

2. The control method according to claim 1, further comprising:
displaying a confirmation screen to confirm whether to duplicate the second content data in a case where the second content data is selected from the second list, wherein
in a case where a first operation is performed on the confirmation screen, the second editing screen is displayed,
in a case where a second operation is performed on the confirmation screen, the second editing screen is not displayed, and
in a case where the first content data is selected from the first list, the first editing screen is displayed without displaying a confirmation screen to confirm whether to duplicate the first content data.

3. The control method according to claim 2, wherein
on the confirmation screen, in a case where the second operation is performed, a predetermined screen to confirm a content of the second content data outputted already is displayed.

4. The control method according to claim 3, wherein
on the predetermined screen, control to prevent a user from editing the second content data is performed.

5. The control method according to claim 3, wherein
a region corresponding to the second content data includes a first button and a second button,
in a case where an operation on the first button is performed, and the first operation is performed on the confirmation screen, the second editing screen is displayed,
in a case where an operation on the first button is performed, and the second operation is performed on the confirmation screen, the predetermined screen is displayed, and
in a case where an operation on the second button is performed, the predetermined screen is displayed.

6. The control method according to claim 1, wherein
a first text, which is displayed on a button that is included in a region corresponding to the first content data in the first list and that displays the first editing screen, and a second text, which is displayed on a button that is included in a region corresponding to the second content data in the second list and that displays the second editing screen, are different from each other.

7. The control method according to claim 6, wherein
the first text is a text indicating editing, and
the second text is a text indicating duplication and editing.

8. The control method according to claim 1, wherein
a region corresponding to the first content data includes a first button and a second button,
in a case where an operation on the first button is performed, the first editing screen is displayed, and
in a case where an operation on the second button is performed, the first content data is deleted.

9. The control method according to claim 1, wherein
outputting of the content data includes printing that is executed by a printing apparatus based on the content data.

10. The control method according to claim 1, wherein
outputting of the content data includes transmitting of the content data to an apparatus outside the information processing apparatus.

11. The control method according to claim 1, wherein
outputting of the content data includes ordering of a content expressed by the content data.

12. The control method according to claim 11, wherein
ordering of a content expressed by the content data includes processing for payment to purchase the content expressed by the content data.

13. The control method according to claim 1, wherein
the first region is displayed with a tab displaying the second region, and
in a case where the tab displaying the second region is selected, the second region is displayed with a tab displaying the first region.

14. The control method according to claim 1, wherein
the content data is data corresponding to a poster or a photo album.

15. The control method according to claim 1, wherein
the first region and the second region are displayed by a WEB browser of the information processing apparatus based on information received from a server outside the information processing apparatus.

16. The control method according to claim 1, wherein
the first editing screen includes a region accepting an operation to save the first content data without outputting and a region accepting an operation to output the first content data, and
the second editing screen includes a region accepting an operation to save the third content data without outputting and a region accepting an operation to output the third content data.

17. The control method according to claim 1, wherein
editing of the content data includes at least one of adding of an object in the content data, moving of an object in the content data, and size changing of an object in the content data.

18. The control method according to claim 1, wherein
the region corresponding to the first content data includes a first button and a second button,
in a case where an operation on the first button is performed, the first editing screen is displayed,
in a case where an operation on the second button is performed, processing of checking a revised portion related to an object in the first content data is executed, and a screen to confirm a content of the first content data is displayed,
a region corresponding to the second content data includes a third button and a fourth button,
in a case where an operation on the third button is performed, the second editing screen is displayed, and
in a case where an operation on the fourth button is performed, processing of checking a revised portion related to an object in the second content data is not executed, and a screen to confirm a content of the second content data is displayed.

19. A non-transitory computer readable storage medium storing a program causing a computer of an information processing apparatus to execute the steps of:
generating content data;
editing the content data based on a user operation;
outputting the content data on which the editing is performed;
displaying a first region indicating a first list, which is a list of the content data that is not outputted yet;
displaying a second region indicating a second list, which is a list of the content data that is outputted already;
displaying a first editing screen to edit first content data in a case where the first content data is selected from the first list;
displaying a second editing screen to edit third content data obtained by duplicating second content data in a case where the second content data is selected from the second list;
performing control to maintain a state in which the second content data is included in the second list indicated by the second region displayed after the second editing screen is displayed even in a case where the second content data is selected from the second list; and
performing control to newly add the third content data to the first list displayed after an operation to save the third content data without outputting is performed on the second editing screen.

20. An information processing apparatus, comprising:
a generation unit configured to generate content data;
an editing unit configured to edit the content data based on a user operation;
an output unit configured to output the content data on which the editing is performed;
a first display unit configured to display a first region indicating a first list, which is a list of the content data that is not outputted yet;
a second display unit configured to display a second region indicating a second list, which is a list of the content data that is outputted already;
a third display unit configured to display a first editing screen to edit first content data in a case where the first content data is selected from the first list;
a fourth display unit configured to display a second editing screen to edit third content data obtained by duplicating second content data in a case where the second content data is selected from the second list;
a first control unit configured to perform control to maintain a state in which the second content data is included in the second list indicated by the second region displayed after the second editing screen is displayed even in a case where the second content data is selected from the second list; and
a second control unit configured to perform control to newly add the third content data to the first list displayed after an operation to save the third content data without outputting is performed on the second editing screen.
